(19) United States
(12) Patent Application Publication
(10) Pub. No.: US 2013/0304674 A1
(43) Pub. Date: Nov. 14, 2013

(54) Property and Casualty Insurance Company with Supporting Membership Entity

(71) Applicant: Robert Isaacs, Fort Lauderdale, FL (US)

(72) Inventor: Robert Isaacs, Fort Lauderdale, FL (US)

(21) Appl. No.: 13/469,905

(22) Filed: May 11, 2012

(51) Int. Cl. G06Q 90/00

(52) U.S. Cl. 705/500

(57) ABSTRACT

A method of providing property, casualty and non-flood insurance includes the steps of establishing a membership entity (“ME”) to provide emergency-related goods and services to members, provide a right to purchase homeowner's property and casualty insurance from a special insurer, enable members of the ME to access the special insurer's network of general contractors for non-claim related repairs at a pre-established price. The insurer establishes internally integrated teams of retained general contractors/adjusters or one person acting as both. Included is a complete inventory, and photographic record of insured's property to minimize the risk of downstream fraud in the adjustment process if a claim occurs. Because of savings to the insurer of the internal contractors/adjusters, the documentation of the insured assets, the access of contractors to construction supplies at warehouses of the ME, the loss ratio of the direct-repair insurer is materially reduced, this markedly lowering the cost of insurance.

### BACKGROUND OF THE INVENTION

Since the beginning of major tropical storms, starting with the Andrew storm in 1991, the securement of property and casualty insurance for homes and businesses in hurricane prone areas of the United States has presented a significant problem, necessitating in many states the assumption, in whole or in part, of the insurance function by states in affected areas, one being the State of Florida. Another consequence of the increased occurrence of serious tropical storms has been the passage of the National Flood Insurance Program (NFIP) for residents of communities that pursuant to NFIP, may adopt and enforce floodplain management ordinances that reflect appropriate land use practices as mandated by the program. NFIP is available regardless of whether the flood risk of a given community, or portion of a community, is high, medium or low, as long as the community participates it, the details of which may be seen on the sites http//www.fema.gov/nfip/how.htm and http//www.floodsmart.gov. The cost thereof is approximately $300 per year per $100,000 of coverage. Resultingly, in states such as Florida, Alabama, Mississippi, Louisiana and the Carolinas, flood coverage cannot be obtained for single-family homes, townhouses, condominiums, and many businesses except through the government sponsored NFIP flood insurance and state-sponsored insurances for other storm-related risks.

Non-flood property and casualty risks, that is, fire, theft, water damage, windstorm, hurricane, and forms of public or guest liability have been left in the private sector. However, because of the high loss ratio (ratio of amount of paid claims to amount received as the insurance premium), the cost of such insurance has become prohibitive in many coastal areas, this to the point where many home and property owners cannot afford such insurance. Resultingly, certain states, such as Florida, have formed or subsidized insurance companies such as Citizens Property and Casualty, the cost of operation of which must be subsidized through tax payer funds, due to the high loss ratio or risk thereof. Neither Florida, nor any other state, wishes to be in the property and casualty insurance business.

Accordingly, a need has developed for additional forms of property and casualty insurance for homeowners and businesses in flood and storm prone areas of the United States. The present inventive business method represents a response to this need which has developed for a form of fire, theft, water damage, and other hurricane-related liability insurance in which the loss ratio thereof would be substantially reduced, and the cost of insurance and re-insurance, to the extent required by the insurer, would also be reduced over conventional levels in such areas. The present invention thereby responds to this need in the art which has existed for many years and, according to projections of global warming and associated increased storm activity, will result in further exacerbation of this problem in the future if it is not otherwise addressed.

The prior art does address actuarial methods of assessment of the risk of catastrophic events, such as major hurricanes, as is reflected in U.S. Patent Application Publication US2004/0186753 A1 (2004) to Kim et al. Kim however teaches an actuarial method having its primary value to re-insurers in their efforts to establish a rate to charge insurers which is reasonable to all parties for the risk involved. A method of funding of certain future liabilities through investment vehicles is taught in U.S. Pat. No. 4,642,768 (1987) to Roberts. This patent is “pre-Andrew” and, as such, does not teach an insurance investment program capable of addressing extreme levels of claims such as are associated with major hurricane events.

Many forms of co-operative or so-called mutual insurance exist, both domestically and abroad, for the purpose of spreading otherwise difficult-to-insure risks among the members of cooperative or mutual insurance associations. One such organization is the Americas Association of Cooperative/Mutual Insurance Societies (AAC/MIS), Mclean, Virginia (see info@aacmis.org http//www.aacmis.org/); Co-Operative Companies of Vermont and New Hampshire. However, with respect to the types of extreme storm-related damage that the instant invention addresses, it is not believed that existing forms of cooperative and mutual insurance are applicable, unless adapted to the inventive method set forth herein.

### SUMMARY OF THE INVENTION

Set forth herein is a method of providing property and casualty insurance comprising the steps of establishing a membership entity (“ME”) to (a) provide a plurality of emergency-related goods and services for its members, (b) provide a right to purchase homeowner's or property and casualty insurance special direct repair (“DRI”) insurer as a “members only” form of insurance, (c) enable members of the ME to access the special insurer's network of general contractors for non-claim related repairs at a pre-established price, and (d) establish and pledge a portion of a ME Fund to re-insure a part of the risk insured by the DRI. The DRI is organized for purposes of establishing internally trained individuals and integrated teams of retained or salaried general contractors/adjusters, assigned as agents of the insurer. The term of the insurance is three years and cannot be cancelled or the premium increased during that term. The application process entails a complete inventory and photographic record of the insured's property to minimize the risk of downstream fraud in the adjustment process when and if a claim occurs. Each policy is portable both as to the insured and the property that is insured. Because of the savings to the insurer of the integrated teams of internal contractors and adjusters, or same person as a contractor/adjuster, the documentation of the insured assets, and the access of contractors to repair and emergency-needed supplies at warehouses of the ME, the loss ratio of the DRI is materially reduced, thereby markedly lowering the cost of operations.

### BRIEF DESCRIPTION OF THE DRAWINGS

FIG. 1 is a flow diagram of the present direct repair insurance program.

FIG. 2 is a block diagram of the policy writing assessment of the prospective property to be insured.

### DETAILED DESCRIPTION OF THE INVENTION

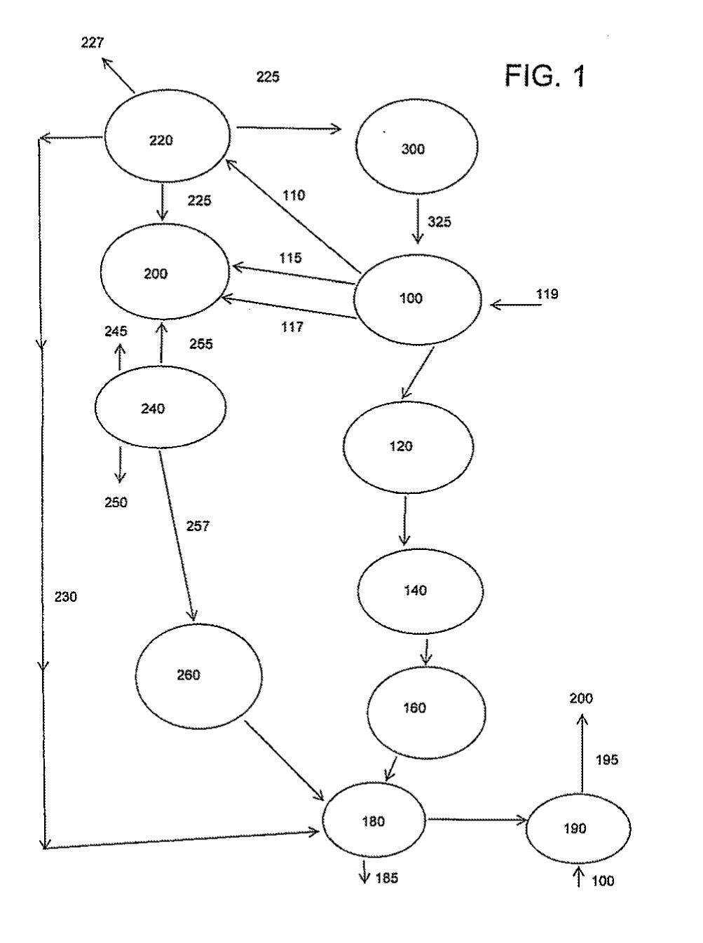

Per FIG. 1, the inventive form of storm and casualty insurance, known as Direct Repair Insurance (DRI) 100 includes a so-called membership club or entity, hereinafter the membership entity (“ME”) 200, the functions of which are as follows:

A. To provide emergency response goods, products, and services to its members in an extreme event situation. See Lines 195 and 225 in FIG. 1, as described below.

B. To provide group purchasing power and advantages with respect to storm-related products 240 and special offers 245 that the ME may identify and facilitate on behalf of its members. See FIG. 1, as described below.

C. To provide a right to purchase homeowner's or business property and casualty insurance 115 from the DRI 100, thereby providing a “member's only” form of insurance.

D. To provide access for members to the DRI's network of retained or salaried contractors/adjusters 120/160 for non-storm repairs and work 185, at pre-established rates, as well as for storm-related repairs 195/230, as is described below.

E. To establish a fund 220 to define a primary source of re-insurance 300 for the DRI 100 through the use of cash or collateral pledge 225.

It is contemplated that the cost of a three-year membership 115 in the ME would on the average be in the range of $1,500, however, in general relation to the value of the policy, with the premium increasing in relation to house size. After said initial three-year membership, it is contemplated that further membership dues would be reduced, unless a major storm has acted to deplete the assets of the ME. Another aspect of membership in the ME is its portable nature, that is, if a member moves to another location within the same state, his right to purchase property and casualty insurance from the DRI would be unimpaired. Alternatively, a member that sells an insured property would have a right to transfer his ME membership, including the unused portion of its term, to the purchaser of that property, upon approval.

It is also contemplated that a letter of credit 110, or other credit mechanism, might become associated with the ME fund 220 to support the DRI 100 for purposes of meeting the regulatory capital reserve requirements associated with any public insurer, without use of reserves of the fund per se. The benefits thereof would pass through to customers of the DRI in the form of reduced cost 117 of premiums.

As noted in the Summary of the Invention above, the present inventive property and casualty method of insurance includes said Direct Repair Insurer (“DRI”) 100 which, as distinguished from a “regular” property and casualty insurance company, operates in several ways that are particular or unique to the present inventive method. More particularly, as above noted, it would first be necessary to join or enroll in said membership entity (“ME”) 200 as a pre-condition to application for insurance from the DRI.

The general purpose of the DRI, as noted in the Background of the Invention above, is the provision of insurance to high-risk coastal and other areas, presently now eligible only for storm related and general property and casualty insurance provided, in essence, by a substantially subsidized arm of state government, in Florida, known as Citizens Insurance Company. The DRI, unlike traditional insurance companies in high-risk areas of the country, may offer, within a single policy insurance of all perils preferably inclusive of wind. Therein, the body of the policy would be substantially the same as that of conventional policies issued by existing property and casualty insurers. The essential differences would, however, lie in the following:

Membership in the above described ME 200 would constitute a pre-condition to application for DRI insurance.

The policies thereof would be guaranteed for a three-year term with a right of renewal as long as one's membership in the ME is in good standing, this in distinction to many policies today, a term of which can be as short as six months, without any right of renewal. As such, a policyholder under the DRI would not have a concern or worry regarding cancellation of his policy by the insurer in the event that a high value claim as a result of a hurricane or other extreme event is made during its terms.

To assist the DRI 100 in the meeting of the statutory capital reserve requirements associated with the licensing and operation of a public insurer, prepayment 119 of each policy, either in cash or through financing, would be required for the entire three-year period of the policy. If necessary, the DRI would assist the insured in the financing of the policy at a reasonable interest rate, since the DRI and the ME would support such financing, as needed.

A material concept of the DRI is that the repair contractor function and the claim adjustment process would be internalized or horizontally integrated by the insurer in the form of a guild 120 (see FIG. 1) to obviate the traditional reliance upon independent contractors for home repair and claims adjustment. It is believed that one of the greatest sources of waste and inefficiency in present day property and casualty insurers that operate in risk areas is in incompetence or negligence which occurs in the claim adjustment process and the greed and overcharging in the contractor repair function which, in the wake of most storms, is an invitation for contractors to overcharge homeowners and, resultingly, the insurer itself.

The present inventive system and method contemplates that the DRI would train its own adjusting/contractor personnel, as opposed to other forms of adjustments and third-party contractors, and in due course fully qualify their internal adjusters as licensed adjusters and general contractors 160 whom, thereafter, would become subject to long-term employment or independent contractor relationships 190 with the DRI 100, becoming fully integrated into the policy aspects and operation of the DRI. In parallel fashion, the DRI would retain, on a long-term basis, or may train its own personnel 140 to become licensed general contractors and adjusters. Therein, the DRI company would seek to recruit individuals who are or could become successfully trained and licensed as both adjusters and general contractors 160, such individuals then becoming bound to long-term arrangements 190 with the DRI or becoming at least part-time employees thereof. It is contemplated that each contractor/adjuster would comprise a team 180, consisting of one contractor and one adjuster, that would have responsibility for a given value of defined insurance policies, e.g., a number of policies per team dictated by needs and procedure of the DRI. Where one person becomes qualified in both areas, then the representative team of the DRI for the insureds of said policy would be that of a single individual or entity having a long-term relationship with such company which would have in its employ at least one general contractor and at least one adjuster such that that entity would become responsible for said group of insureds. Whether through an arrangement of teams of contractors and adjusters, an individual who is both, or an entity having in its employ both a general contractor and an adjuster, such persons or individuals would be compensated on a regular, fixed cost basis 190 by the DRI such that the inventive insurance entity will have a first call or right to the services 180 of these individuals in the event of a storm, or any other insurance-intensive entity. Incremental compensation 230 would be paid during repairs of extreme events.

A benefit of becoming a member of the DRI organization or network would be that the general contractors/adjusters belonging thereto will (as noted above), through the function of the ME, have a right to contact any member of the ME for non-storm repairs or work 185, at a pre-established price basis.

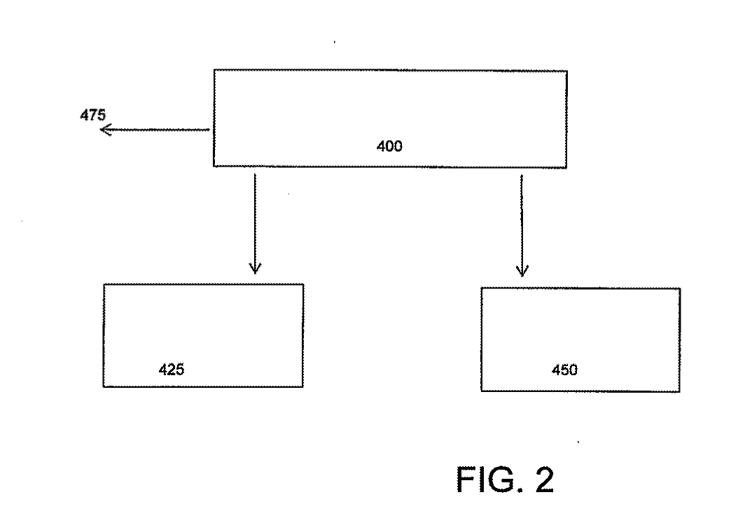

From the perspective of reduction of cost of operation of the DRI, without which the objectives of the inventive system and method cannot be obtained, it is contemplated that contractors/adjusters which are retained on a long-term basis by the DRI will exhibit a much higher degree of competence and integrity than that which is now prevalent in the adjuster and repair function. A factor which will contribute to the success of the use of “company” adjusters is that, prior to the acceptance of a policy holder, the DRI would require a complete survey 400 of the home or business as it exists at the time of writing of the policy (see FIG. 2), this inclusive of inventory 425 and videos 450 of the premises, to assist in avoidance of discrepancies that might arise between the time the policy is written and the time that a claim is made. The same procedure would follow for high value types of personal property such as jewelry, collectibles and the like. The insured would be required to report any changes or additions to the home or personal property exceeding $5000 per item after the writing of the policy, or it would be excluded from coverage. It is contemplated that the same procedure may be repeated every three years upon renewal of the above-described three-year policy.

Another source of savings to the DRI which would render possible the objects of the invention, the most important of which is the provision of non-flood insurance in high risk areas, is that the general contractor/adjuster, which is either employed by the DRI or is retained on a priority basis in the event of need for his services, would be required to effect repairs 195 needed as a result of a storm, or other work 185 in accordance with a schedule of costs which has been pre-agreed upon by the contractors/adjusters. In addition, through the various emergency response products 240 of the ME, described above, many of materials 250 required for repair, otherwise subject to cost gouging in the event of a storm or the like, or simply subject to unavailability, would be made available to the DRI contractors/adjusters 180.

After a storm or any insurable event has occurred, the insured would have the option 225 of either having the repairs done by the general contractor/adjuster 180 affiliated with the DRI, or simply accepting the amount for necessary repairs as the contractor/adjuster of the DRI assigned to the particular insured has estimated it. In other words, an insured would not be compelled to use the services of a DRI employed or affiliated contractor/adjuster but, rather, could elect to accept the amount of an estimate for compensation for one's property and casualty damage. If this option is elected, all such repairs would be inspected to assure a repair of like kind and quality, or better, to enable continuation of the DRI policy.

It would be the decision of the insured whether or not to permit the DRI entity, through it contractors, to repair the covered damages or accept the value thereof as complete settlement. This process, in combination with the above-described establishing of a record 400 of the nature of the property to be insured at the inception of the policy, will eliminate disputes, reduce the cost to insurers, and generally bring about a reduced loss ratio, from which the insured will benefit in terms both of inherent profitability and reduction in the DRI's cost.

As a further means of reducing the cost of the premium to the insured and of reducing the cost of renewal of membership in the above-described ME after the initial three-year term, the DRI may contractually agree to limit 227 its net profit of 6-10% of gross premiums collected. See FIG. 1. Profits in excess of that amount might, for example, be contributed to the above-referenced ME Fund 220 of other DRI Functions.

It is anticipated that the per annum cost of a DRI policy will reflect a substantial premium reduction. Thereafter, it is anticipated that demonstration of reduction in the lost ratio of the resultant company, operating with the inventive as set forth herein, will result in reduced cost of re-insurance 300 as well as absolute reduction of cost of operation such that the price of all peril property and casualty insurance in what, at present, are high loss ratio areas, that is, Florida, Texas, Mississippi, Alabama, Louisiana and earthquake prone regions, will be reduced to a level which such insurance would be affordable to most homeowners and states, such as Florida, that have been compelled to enter the insurance business will be able to exit therefrom.

A strategy of the DRI, in minimizing the cost to it in an extreme event that might otherwise render it insolvent, would be to diversify exposure by avoiding excessive policy density in small or limited area 475 (see FIG. 2), this having the added benefit of enabling the available emergency response goods and services of the ME to more readily function within specific geographical limits, that is, from becoming exhausted by reason of an excessive number of policy holders having requirements within a small geographical area. That is, through diversification of exposure of the probability that a serious storm or extreme event in one area will place an excessive drain upon the resources of the DRI, total loss factor risk is reduced while the ability to offer meaningful insurance and manpower 260 throughout a very large area is enhanced.

As above noted, a further feature of the DRI insurance would be its portability, that is, a DRI insurance policy would be susceptible to transfer with a property that is sold and, also, a homeowner moving to a different area within a state of business of the DRI would similarly be permitted to transfer his insurability to a new homestead. This feature would render it easier for persons to sell and purchase homes in different areas within the region of business of the DRI.

While there has been shown and described the preferred embodiment of the instant invention it is to be appreciated that the invention may be embodied otherwise than is herein specifically shown and described and that, within said embodiment, certain changes may be made in the form and arrangement of the parts without departing from the underlying ideas, principles and Claims of this invention as set forth herewith.

1. (canceled)

2. (canceled)

3. (canceled)

4. (canceled)

5. (canceled)

6. (canceled)

7. (canceled)

8. (canceled)

9. (canceled)

10. (canceled)

11. The method as recited in claim 19, in which one of said contractors and one of said adjusters of said guild comprise the same individual.

12. The method as recited in claim 11 further comprising:
pre-paying of certain fees of members of said guild.

13. The method as recited in claim 19, further comprising:
using a portion of the premiums from the DRIO members to purchase re-insurance or use as re-insurance.

14. (canceled)

15. The method as recited in claim 19, in which said imposing procedures for limitation of adjustment fraud includes:
providing a photographic and inventory records of the condition and contents of each insured property, prior to inception of a given casualty insurance policy.

16. The method as recited in claim 20, further including the step of:
rendering said contractors available for discounted non-claim work.

17. The method as recited in claim 21, further including:
rendering available to certain members of a subset of the ME, during non-storm periods, stockpiled storm-related supplies at a discount price.

18. The method as recited in claim 20, further comprising:
providing portability of each policy as to both ME property owner and the property insured.

19. A method of reducing the cost of non-flood home casualty insurance, comprising the steps of:
(a) identifying populations of home owners in a zip and/or defined geographical area;
(b) in Step (a) above, defining a size limit of sub-sets of said populations in each said area for prospective membership in a direct repair insurance or organization (TRIO″);
(c) creating a membership entity (“ME”) consisting of a plurality of sub-entities of persons within each area that elect to join said DRIO, membership in said ME requiring an agreement to employ repair services and to follow membership rules of said DRIO;
(d) said DRIO providing a captive guild of contractors and insurance adjusters controlled by said DRIO, said guild in the event of natural disasters such as extreme storms; accessible by said ME;
(e) imposing procedures for the limitation of risk of adjustment fraud as a membership requirement of said DRIO and employment of said adjusters by said guild of said DRIO; and
(f) providing of insurance premiums or rates based upon replacement value of insured property regardless of the location of a member's property within said zip code or defined area of Step (a),
whereby the loss ratio of said DRIO as compared to that of conventional casualty insurance is materially reduced.

20. The method as recited in claim 15, further comprising:
providing multi-year insurance policies having premiums or rates on a fixed annual basis determined upon the inception of a policy.

21. The method as recited in claim 19, further comprising:
stockpiling of storm-related supplies for use by said DRIO and members of said ME;
